(19) United States
(12) Patent Application Publication
(10) Pub. No.: US 2021/0388185 A1
(43) Pub. Date: Dec. 16, 2021

(54) PNEUMATIC TIRE

(71) Applicant: Toyo Tire Corporation, Itami-shi (JP)

(72) Inventors: Yuma Nishikawa, Itami-shi (JP); Norio Minouchi, Itami-shi (JP)

(73) Assignee: Toyo Tire Corporation, Itami-shi (JP)

(21) Appl. No.: 17/330,735

(22) Filed: May 26, 2021

(30) Foreign Application Priority Data
Jun. 10, 2020 (JP) 2020-101244

(51) Int. Cl. C08L 7/00; B60C 9/18

(52) U.S. Cl. CPC C08L 7/00; B60C 2001/0066; B60C 9/1835

(57) ABSTRACT

A pneumatic tire according to an embodiment is a pneumatic tire including a belt pad disposed between a belt end and a carcass ply. The belt pad is formed by a rubber composition containing 1 to 10 parts by mass of sulfur, 0.1 to 5 parts by mass of N,N-dibenzylbenzothiazole-2-sulfenamide, and 0.1 to 5 parts by mass of either one or both of 1,6-bis(N,N-dibenzylthiocarbamoyldithio)hexane and hexamethylene bis-thiosulfate disodium salt dihydrate, with respect to 100 parts by mass of diene rubber.

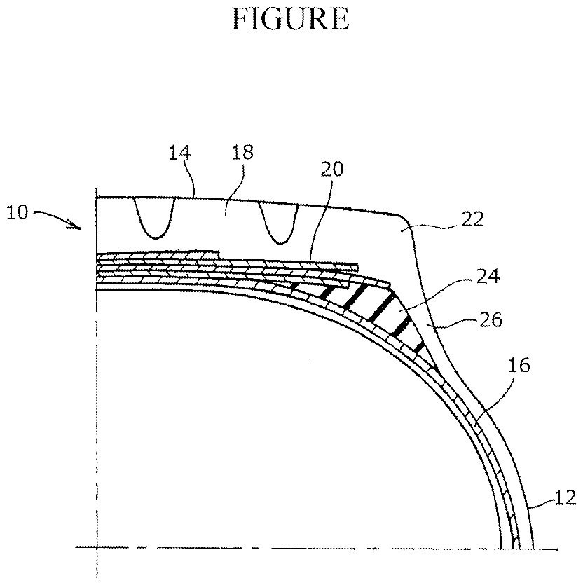

### CROSS-REFERENCE TO RELATED APPLICATIONS

This application is based upon and claims the benefit of priority from the prior Japanese Patent Application No. 2020-101244, filed on Jun. 10, 2020; the entire contents of which are incorporated herein by reference.

### BACKGROUND

### 1. Field of the Invention

The present disclosure relates to a pneumatic tire.

### 2. Description of Related Art

A rubber member referred to as a belt pad extending in a tire circumferential direction may be disposed between a belt end and a carcass ply on a shoulder of a pneumatic tire. For example, JP-A-2009-248771 discloses that as a rubber composition to be used for the belt pad, a phenolic compound or a phenolic resin and hexamethylenetetramine or a melamine derivative as a methylene donor thereof are mixed, and 1,6-bis(N,N-dibenzylthiocarbamoyldithio)hexane is mixed, thereby improving heat aging resistance.

JP-A-2008-308632 discloses that a rubber composition forming a composite together with a metal material is mixed with N,N-dibenzylbenzothiazole-2-sulfenamide (DBBS) as a vulcanization accelerator.

JP-A-2003-082586 discloses that hexamethylene bis-thiosulfate disodium salt dihydrate and 1,6-bis(N,N-dibenzylthiocarbamoyldithio)hexane are mixed with a rubber composition for coating a tire cord.

### SUMMARY

A belt pad is a member adjacent to a belt and a carcass ply containing a metal material, and is repeatedly subjected to a load during tire traveling between a belt end and the carcass ply. Therefore, heat aging resistance is required to maintain high rigidity even after aging, and crack growth resistance is required to prevent adhesive failure with the belt and the carcass ply. In order to improve the heat aging resistance of the rubber composition and the crack growth resistance thereof, for example, it is desirable to use a raw material that has little influence on an environment with respect to a vulcanization accelerator and an organic acid metal salt.

An object of an embodiment of the present disclosure is to provide a pneumatic tire capable of improving heat aging resistance and crack growth resistance of a belt pad, while reducing a usage amount of a raw material that may have an influence on an environment.

A pneumatic tire according to an embodiment of the present disclosure is a pneumatic tire including a belt pad disposed between a belt end and a carcass ply. The belt pad is manufactured by using a rubber composition containing 1 to 10 parts by mass of sulfur, 0.1 to 5 parts by mass of N,N-dibenzylbenzothiazole-2-sulfenamide, and 0.1 to 5 parts by mass of either one or both of 1,6-bis(N,N-dibenzylthiocarbamoyldithio)hexane and hexamethylene bis-thiosulfate disodium salt dihydrate, with respect to 100 parts by mass of diene rubber.

The rubber composition may not contain cobalt organic acid, or a content of the cobalt organic acid may be 3 parts by mass or less with respect to 100 parts by mass of diene rubber.

According to an embodiment of the present disclosure, while N,N-dibenzylbenzothiazole-2-sulfenamide having little influence on an environment is used as a vulcanization accelerator, either one or both of 1,6-bis(N,N-dibenzylthiocarbamoyldithio)hexane and hexamethylene bis-thiosulfate disodium salt dihydrate are mixed with a rubber composition. As a result, heat aging resistance and crack growth resistance of a belt pad can be significantly improved. Therefore, even though cobalt organic acid which may have an influence on the environment is not necessarily contained in the rubber composition, the belt pad can have excellent heat aging resistance and crack growth resistance.

### BRIEF DESCRIPTION OF THE DRAWING

FIGURE is an enlarged cross-sectional view of a part of a tire showing one embodiment.

### DESCRIPTION OF EMBODIMENTS

Hereinafter, embodiments of the present disclosure will be described in detail.

FIGURE is an enlarged cross-sectional view of a part of a pneumatic tire 10 according to one embodiment. The pneumatic tire 10 is a pneumatic radial tire including a pair of left and right bead portions (not illustrated), a pair of left and right sidewalls 12, a tread 14 provided between both sidewalls 12 so as to connect radial outward ends of the left and right sidewalls 12 to each other, and at least one carcass ply 16 extending across the pair of left and right bead portions.

The carcass ply 16 extends from the tread 14 to the sidewall 12, and both ends thereof are locked by the bead portions to reinforce each of the portions, and in this example, a steel cord is disposed radially, that is, in a radial pattern.

A belt 20 is provided between a tread rubber 18 and an outer peripheral side of the carcass ply 16 in the tread 14. The belt 20 is formed of two or more belt plies in which the steel cords are disposed inclinedly with respect to a tire circumferential direction, and in this example, four belt plies are stacked.

In a shoulder 22 between the tread 14 and the sidewall 12, a belt pad 24 extending in the tire circumferential direction is disposed between the belt 20 and the carcass ply 16. The belt pad 24 is a band-shaped rubber member having an approximately triangular cross section shape that fills a gap between an end of the belt 20 and the carcass ply 16, and is disposed along the whole circumference in the tire circumferential direction of both sides of the tire cross section. The belt pad 24 is a rubber member that is not exposed on a tire outer surface. More specifically, an outer surface of the belt pad 24 in a tire width direction is covered with a rubber layer 26 forming the tire outer surface, whereby the belt pad 24 is embedded inside the tire.

The belt pad 24 uses a rubber composition containing 1 to 10 parts by mass of sulfur, 0.1 to 5 parts by mass of N,N-dibenzylbenzothiazole-2-sulfenamide, and 0.1 to 5 parts by mass of either one or both of 1,6-bis(N,N-dibenzylthiocarbamoyldithio)hexane and hexamethylene bis-thiosulfate disodium salt dihydrate, with respect to 100 parts by mass of diene rubber.

In the rubber composition, as the diene rubber as a rubber component, examples thereof include natural rubber (NR), isoprene rubber (IR), butadiene rubber (BR), styrene butadiene rubber (SBR), nitrile rubber (NBR), styrene isoprene copolymer rubber, styrene isoprene butadiene copolymer rubber, or the like. Among the examples thereof, any one type may be used alone or two or more types may be used in combination. Among the examples thereof, diene rubber desirably contains natural rubber because natural rubber has an excellent fracture characteristic. The diene rubber may be natural rubber alone, or may contain other types of diene rubber together with natural rubber. As other types of diene rubber, it is desirable to use at least one type to be selected from a group consisting of IR, BR, and SBR.

The 100 parts by mass of diene rubber desirably contains 50 parts by mass or more of natural rubber, more desirably contains 70 parts by mass or more of natural rubber, much more desirably contains 80 parts by mass or more of natural rubber, and may contain 100 parts by mass of natural rubber.

In the rubber composition, as sulfur as a vulcanizing agent, examples thereof include powdered sulfur, precipitated sulfur, colloidal sulfur, insoluble sulfur, oil-treated sulfur, or the like. A mixing amount of sulfur is desirably 1 to 10 parts by mass, more desirably 2 to 8 parts by mass, and may be 4 to 6 parts by mass, with respect to 100 parts by mass of the diene rubber.

In the rubber composition, N,N-dibenzylbenzothiazole-2-sulfenamide (DBBS) (another name: 2-[(dibenzylamino)thio]benzothiazole) is used as the vulcanization accelerator. DBBS is a compound represented by the formula (1) below. DBBS has little influence on the environment of a secondary amine generated during vulcanization reaction with respect to N,N-dicyclohexyl-2-benzothiazolesulfenamide (DCBS) which may have an influence on the environment, and a rubber physical characteristic of DBBS after vulcanization also does not deteriorate. Since DBBS also has a relatively slow vulcanization rate and excellent sulfur dispersion, DBBS has better physical properties as a rubber member adjacent to a metal material than those of other vulcanization accelerators such as N-(tert-butyl)-2-benzothiazolesulfenamide (TBBS) or the like.

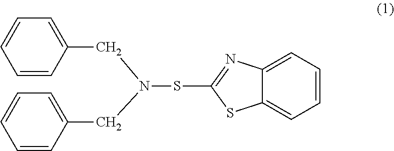 [SMILES: c1ccc(CN(Cc2ccccc2)Sc2nc3ccccc3s2)cc1]

A mixing amount of N,N-dibenzylbenzothiazole-2-sulfenamide is desirably 0.1 to 5 parts by mass, more desirably 0.5 to 4 parts by mass, and much more desirably 0.8 to 3 parts by mass, with respect to 100 parts by mass of the diene rubber.

As the vulcanization accelerator, N,N-dibenzylbenzothiazole-2-sulfenamide alone is desirably used, and other vulcanization accelerators such as N-(tert-butyl)-2-benzothiazolesulfenamide or the like may be used in combination. It is desirable that N,N-dicyclohexyl-2-benzothiazolesulfenamide is not contained as much as possible. Even though N,N-dicyclohexyl-2-benzothiazolesulfenamide is contained, the mixing amount thereof is desirably 0.5 part by mass or less, and more desirably 0.3 part by mass or less, with respect to 100 parts by mass of the diene rubber.

Either one or both of 1,6-bis(N,N-dibenzylthiocarbamoyldithio)hexane and hexamethylene bis-thiosulfate disodium salt dihydrate are mixed with the rubber composition. 1,6-bis(N, N-dibenzylthiocarbamoyldithio)hexane is a thiocarbamoyl compound represented by the following formula (2). Hexamethylene bis-thiosulfate disodium salt dihydrate is a thiosulfate salt represented by the following formula (3).

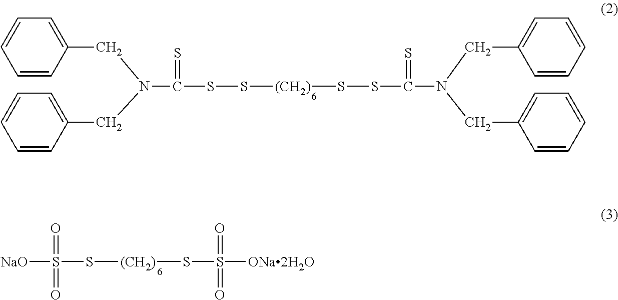

It is considered that these compounds form a —Sₓ—S—(CH₂)₆—S—S_{y}— bond. The bond is more thermally stable than a polysulfide bond, thereby having an effect of improving heat resistance. Therefore, high rigidity can be maintained even after aging, and crack growth resistance can be significantly improved in combination with N,N-dibenzylbenzothiazole-2-sulfenamide as the vulcanization accelerator as described above. Therefore, even though cobalt organic acid is not necessarily contained in the rubber composition, excellent heat aging resistance and crack growth resistance as the belt pad can be obtained.

A mixing amount of 1,6-bis(N,N-dibenzylthiocarbamoyldithio) hexane and/or hexamethylene bis-thiosulfate disodium salt dihydrate (when only either one of the two is mixed, the mixing amount thereof indicates a mixing amount of only one, and when both are mixed, the mixing amount thereof indicates a total amount of a mixing amount of both) is desirably 0.1 to 5 parts by mass, more desirably 0.3 to 4 parts by mass, and much more desirably 0.5 to 4 parts by mass, with respect to 100 parts by mass of the diene rubber, and may be 1 to 3 parts by mass with respect thereto.

The cobalt organic acid is not contained in the rubber composition, or even though the cobalt organic acid is contained therein, a content of the cobalt organic acid is desirably 3 parts by mass or less with respect to 100 parts by mass of the diene rubber. It is desirable that the cobalt organic acid is mixed with the rubber composition from a viewpoint of the heat aging resistance and the crack growth resistance, but it is desirable to reduce a usage amount of the cobalt organic acid from a viewpoint of the influence on the environment. In the present embodiment, the heat aging resistance and the crack growth resistance can be significantly improved by combining N,N-dibenzylbenzothiazole-2-sulfenamide with 1,6-bis(N,N-dibenzylthiocarbamoyldithio)hexane and/or hexamethylene bis-thiosulfate disodium salt dihydrate. Therefore, even though the usage amount of the cobalt organic acid is reduced, the heat aging resistance and the crack growth resistance equal to or higher than those of a related-art product can be obtained.

The mixing amount of the cobalt organic acid is more desirably 2 parts by mass or less, and much more desirably 1 part by mass or less, with respect to 100 parts by mass of the diene rubber, and may be 0.5 part by mass or less with respect thereto. In one embodiment, the mixing amount of the cobalt organic acid may be 0.2 to 1 part by mass with respect to 100 parts by mass of the diene rubber. A content of the cobalt organic acid in terms of metallic cobalt is desirably 0.3 part by mass or less, more desirably 0.2 part by mass or less, and much more desirably 0.1 part by mass or less, with respect to 100 parts by mass of the diene rubber, and may be 0.05 part by mass or less with respect thereto. In one embodiment, the content of the cobalt organic acid in terms of metallic cobalt may be 0.02 to 0.1 part by mass with respect to 100 parts by mass of the diene rubber.

As the cobalt organic acid, examples thereof include cobalt naphthenate, cobalt stearate, cobalt oleate, cobalt neodecanoate, cobalt rosinate, cobalt borate, cobalt maleate, or the like. Among the examples thereof, cobalt naphthenate and cobalt stearate are particularly desirable from a viewpoint of processability.

It is desirable that the rubber composition is mixed with a phenolic compound and/or a phenolic resin obtained by condensing the phenolic compound with formaldehyde as a methylene receptor, and hexamethylenetetramine and/or a melamine derivative as a methylene donor. The adhesiveness with respect to the belt and the carcass ply can be improved by curing the rubber by using the phenolic compound and/or the phenolic resin, and the hexamethylenetetramine and/or the melamine derivative.

As the phenolic compounds, examples thereof include phenol, resorcinol, or an alkyl derivative thereof. The alkyl derivative includes a derivative formed of a relatively long-chain alkyl group such as nonylphenol and octylphenol in addition to a methyl group derivative such as cresol and xylenol. The phenolic compound may contain an acyl group such as an acetyl group or the like as a substituent.

The phenolic resin includes a formaldehyde resin including a plurality of phenolic compounds in addition to a resorcinol-formaldehyde resin, a phenol resin (that is, a phenol-formaldehyde resin), a cresol resin (that is, a cresol-formaldehyde resin), or the like. The above-described resins are uncured resins, and resins which are liquid or have thermal fluidity are used for the above-described resins.

Among the examples thereof, resorcinol and/or a resorcinol resin are desirable as the methylene receptor. As the resorcinol resin, an example thereof includes the one obtained by condensing at least one type selected from a group consisting of resorcinol and its alkyl derivative with aldehyde such as formaldehyde or the like, and other monomer components such as alkylphenol or the like may be used together. Specifically, the resorcinol-formaldehyde resin obtained by condensation of resorcinol and formaldehyde, and a resorcinol-alkylphenol-formaldehyde resin obtained by condensation of resorcinol, alkylphenol, and formaldehyde are desirable.

A mixing amount of the phenolic compound and/or the phenolic resin is not particularly limited. The mixing amount thereof is desirably 0.5 to 5 parts by mass, and more desirably 0.5 to 3 parts by mass, with respect to 100 parts by mass of the diene rubber.

As the melamine derivative, examples thereof include methylol melamine, a partially etherified product of methylol melamine, a condensate of melamine, formaldehyde, and methanol, or the like. Among the examples thereof, hexamethoxymethylmelamine is particularly desirable.

A mixing amount of the hexamethylenetetramine and/or the melamine derivative is only an amount enough to sufficiently perform reaction and curing with respect to the phenolic compound and/or the phenolic resin. Specifically, the mixing amount thereof is desirably 0.5 to 2 times the parts by mass of the mixing amount of the phenolic compound and/or the phenolic resin.

Carbon black and/or silica can be mixed with the rubber composition as a reinforcing filler. Carbon black is not particularly limited, and examples thereof include SAF class (N100 series), ISAF class (N200 series), HAF class (N300 series), and FEF class (N500 series) (both ASTM grade). Any one type of the examples or a combination of two or more types of the examples can be used. The HAF class is more desirable. An example of silica includes wet silica such as wet sedimentation method silica, wet gel method silica, or the like.

A mixing amount of the reinforcing filler is not particularly limited. For example, the mixing amount thereof may be 20 to 100 parts by mass, 20 to 80 parts by mass, or 30 to 60 parts by mass, with respect to 100 parts by mass of the diene rubber. A mixing amount of carbon black is not particularly limited, and may be 20 to 70 parts by mass or 30 to 60 parts by mass, with respect to 100 parts by mass of the diene rubber. It can also be said that it is desirable to use a relatively small amount of silica in order to improve the crack growth resistance. In that case, a mixing amount of silica is desirably 1 to 20 parts by mass, and more desirably 3 to 10 parts by mass, with respect to 100 parts by mass of the diene rubber.

In addition to the above-described components, various additives generally used in the type of rubber composition such as zinc oxide, an anti-aging agent, a softener, stearic acid, a wax, a processing aid, or the like can be freely and selectively mixed with the rubber composition.

The rubber composition can be manufactured by kneading according to a related-art method by using a normally used mixing machine such as a Banbury mixer, a kneader, a roll, or the like. That is, in a first mixing step, 1,6-bis(N,N-dibenzylthiocarbamoyldithio)hexane and hexamethylene bis-thiosulfate disodium salt dihydrate, and other additives except sulfur and a vulcanization accelerator are added to diene rubber and mixed therewith. Next, the sulfur and the vulcanization accelerator are added to the obtained mixture and mixed therewith in a final mixing step. Accordingly, it is possible to manufacture the rubber composition.

The rubber composition can be used as a belt pad for various types of pneumatic tires, and is desirably used as a belt pad for heavy-duty pneumatic tires such as a truck, a bus, a light truck, or the like. An unvulcanized tire can be manufactured by using the rubber composition according to a related-art method, and vulcanized and molded at, for example, 140 to 180° C., thereby manufacturing the pneumatic tire.

### Examples

Hereinafter, the present disclosure will be described in more detail with reference to Examples, and the present disclosure is not limited to the Examples.

The Banbury mixer is used, and the rubber composition for the belt pad is manufactured according to a related-art method according to composition (parts by mass) shown in Table 1 below. Specifically, in a first mixing step, another compounding agent except the sulfur and the vulcanization accelerator is added to diene rubber and kneaded therewith (discharge temperature=150° C.). Next, the sulfur and the vulcanization accelerator are added to the obtained kneaded material and kneaded therewith in a final mixing step (discharge temperature=110° C.), thereby manufacturing the rubber composition. Respective components in Table 1 are described as follows.

Natural rubber: RSS #3

Carbon black: “Seast 300 (HAF-LS)” manufactured by Tokai Carbon Co., Ltd.

Silica: “Nipsil AQ” manufactured by Tosoh Silica Corporation

Zinc oxide: “Zinc oxide No. 3” manufactured by Mitsui Mining & Smelting Co., Ltd.

Anti-aging agent: “Santoflex 6PPD” manufactured by Flexis Co., Ltd.

Cobalt stearate: “Cobalt stearate” manufactured by ENEOS Corporation. (Co content 9.5% by mass)

Melamine derivative: Hexamethoxymethylmelamine, “Ciretz 963L” manufactured by Mitsui Cytec Co., Ltd.

Resorcinol resin: resorcinol-alkylphenol-formaldehyde resin, “Sumikanol 620” manufactured by Sumitomo Chemical Co., Ltd.

KA9188: 1,6-bis(N,N-dibenzylthiocarbamoyldithio) hexane, “Vulcrene KA9188” manufactured by LANXESS

HTS: Hexamethylene bis-thiosulfate disodium salt dihydrate, “Duralink HTS” manufactured by Eastman Chemical Company

Insoluble sulfur: “Crystex HS OT-20” manufactured by Flexis (80% by mass is sulfur content)

DCBS: N,N-dicyclohexyl-2-benzothiazolesulfenamide, “Noxeller DZ-G” manufactured by Ouchi Shinko Chemical Industrial Co., Ltd.

TBBS: N-(tert-butyl)-2-benzothiazolesulfenamide, “Sanceler NS-G” manufactured by Sanshin Chemical Industry Co., Ltd.

DBBS: N, N-dibenzylbenzothiazole-2-sulfenamide

The heat aging resistance and the crack growth resistance are evaluated for each of the obtained rubber compositions. An evaluation method is described as follows.

### Heat Aging Resistance

Each rubber composition is vulcanized at 150° C.×30 minutes to prepare a test piece. The test piece is subjected to a tensile test (using a type 3 dumbbell) in accordance with JIS K6251 by using an unaged test piece and a test piece aged in Geer type Oven at 90° C. for 96 hours, thereby calculating a tensile product (fracture elongation×fracture stress). A calculated value after aging is calculated by a percentage with respect to a calculated value of non-aging, and is defined as a retention of tensile product. A value of a retention of tensile product of Comparative Example 1 is set to 100, and a retention of tensile product of each example is displayed with an index. It is indicated that as a value is higher, the heat aging resistance is excellent.

### Crack Growth Resistance

A test sample is prepared by vulcanizing each rubber composition at 150° C.×30 minutes, and aged in Geer type Oven at 90° C. for 24 hours. Next, a bending crack growth test is performed on the test sample in accordance with JIS K6260. The number of times until the crack growth reaches 2 mm is obtained, and a value of each example is shown with an index when a value of Comparative Example 1 is set to 100. As the index is higher, a crack growth rate is slow and fatigue resistance is excellent.

TABLE 1

| | Com. | Com. | Com. | Com. | Com. | Em. | Em. | Em. | Em. | Em. | Em. | Em. | Em. | Em. |
|---|---|---|---|---|---|---|---|---|---|---|---|---|---|---|
| | 1 | 2 | 3 | 4 | 5 | 1 | 2 | 3 | 4 | 5 | 6 | 7 | 8 | 9 |
| Composition | | | | | | | | | | | | | | |
| (parts by mass) | | | | | | | | | | | | | | |
| Natural rubber | 100 | 100 | 100 | 100 | 100 | 100 | 100 | 100 | 100 | 100 | 100 | 100 | 100 | 100 |
| Carbon black | 40 | 40 | 40 | 40 | 40 | 40 | 40 | 40 | 40 | 40 | 40 | 40 | 40 | 40 |
| Silica | 5 | 5 | 5 | 5 | 5 | 5 | 5 | 5 | 5 | 5 | 5 | 5 | 5 | 5 |
| Zinc oxide | 8 | 8 | 8 | 8 | 8 | 8 | 8 | 8 | 8 | 8 | 8 | 8 | 8 | 8 |
| Anti-aging agent | 2 | 2 | 2 | 2 | 2 | 2 | 2 | 2 | 2 | 2 | 2 | 2 | 2 | 2 |
| Cobalt stearate | 2 | 2 | 2 | — | 2 | 2 | 2 | 2 | 1 | 0.5 | — | 2 | 2 | 2 |
| Melamine | 1.5 | 1.5 | 1.5 | 1.5 | 1.5 | 1.5 | 1.5 | 1.5 | 1.5 | 1.5 | 1.5 | 1.5 | 1.5 | 1.5 |
| derivative | | | | | | | | | | | | | | |
| Resorcinol resin | 1 | 1 | 1 | 1 | 1 | 1 | 1 | 1 | 1 | 1 | 1 | 1 | 1 | 1 |
| KA9188 | — | 2 | — | 2 | 2 | 2 | 2 | 2 | 2 | 2 | 2 | 0.5 | 4 | — |
| HTS | — | — | — | — | — | — | — | — | — | — | — | — | — | — |
| Insoluble sulfur | 4 | 4 | 4 | 4 | 4 | 4 | 4 | 4 | 4 | 4 | 4 | 4 | 4 | 4 |
| DCBS | 1 | 1 | — | 1 | — | — | — | — | — | — | — | — | — | — |
| TBBS | — | — | — | — | 1 | — | — | — | — | — | — | — | — | — |
| DBBS | — | — | 1 | — | — | 1 | 2 | 4 | 1 | 1 | 1 | 1 | 1 | 1 |
| Evaluation | | | | | | | | | | | | | | |
| (index) | | | | | | | | | | | | | | |
| Heat aging | 100 | 120 | 105 | 85 | 130 | 136 | 142 | 145 | 128 | 114 | 102 | 109 | 140 | 132 |
| resistance | | | | | | | | | | | | | | |
| Crack growth | 100 | 110 | 110 | 60 | 115 | 145 | 152 | 140 | 139 | 122 | 100 | 110 | 132 | 125 |
| resistance | | | | | | | | | | | | | | |

Results are shown in Table 1. In comparison with Comparative Example 1 in which DCBS is used as the vulcanization accelerator, the heat aging resistance and the crack growth resistance are improved in Comparative Example 2 in which KA9188 is added, but, particularly, in terms of the crack growth resistance, an improvement range is not large enough. Therefore, in Comparative Example 4 in which cobalt stearate is removed from Comparative Example 2, the heat aging resistance and the crack growth resistance significantly deteriorate in comparison with Comparative Example 1 as a control. In Comparative Example 3 in which the vulcanization accelerator is simply replaced with DBBS from DCBS, an effect of improving the heat aging resistance and the crack growth resistance is small in comparison with Comparative Example 1.

On the other hand, in Examples 1 to 3, 7, and 8 in which KA9188 and the vulcanization accelerator DBBS are mixed, the heat aging resistance and the crack growth resistance are significantly improved in comparison with Comparative Example 1 which is the control. Therefore, as shown in Examples 4 to 6, even when a usage amount of cobalt stearate is reduced, or cobalt stearate is not mixed, performance equal to or higher than that of Comparative Example 1 which is the control is obtained, such that excellent heat aging resistance and crack growth resistance can be obtained.

Also, in Example 9 in which HTS and the vulcanization accelerator DBBS are mixed, a significant improvement effect in the heat aging resistance and the crack growth resistance is obtained in comparison with Comparative Example 1 which is the control. By referring to comparison between Example 1 and Example 9, as a compound to be combined with the vulcanization accelerator DBBS, KA9188 has a higher effect of improving the heat aging resistance and the crack growth resistance than that of HTS.

What is claimed is:

1. A pneumatic tire, comprising:
a belt pad disposed between a belt end and a carcass ply,
wherein the belt pad is formed by a rubber composition containing 1 to 10 parts by mass of sulfur, 0.1 to 5 parts by mass of N,N-dibenzylbenzothiazole-2-sulfenamide, and 0.1 to 5 parts by mass of either one or both of 1,6-bis(N,N-dibenzylthiocarbamoyldithio)hexane and hexamethylene bis-thiosulfate disodium salt dihydrate, with respect to 100 parts by mass of diene rubber.

2. The pneumatic tire according to claim 1,
wherein the rubber composition does not contain cobalt organic acid, or a content of the cobalt organic acid is 3 parts by mass or less with respect to the 100 parts by mass of diene rubber.

3. The pneumatic tire according to claim 1,
wherein the rubber composition contains the 1,6-bis(N,N-dibenzylthiocarbamoyldithio)hexane.

4. The pneumatic tire according to claim 2,
wherein the rubber composition contains the 1,6-bis(N,N-dibenzylthiocarbamoyldithio)hexane.

5. The pneumatic tire according to claim 1,
wherein the rubber composition contains the hexamethylene bis-thiosulfate disodium salt dihydrate.

6. The pneumatic tire according to claim 2,
wherein the rubber composition contains the hexamethylene bis-thiosulfate disodium salt dihydrate.

7. The pneumatic tire according to claim 1,
wherein the 100 parts by mass of diene rubber contains 50 parts by mass or more of natural rubber.

8. The pneumatic tire according to claim 2,
wherein the 100 parts by mass of diene rubber contains 50 parts by mass or more of natural rubber.

9. The pneumatic tire according to claim 1,
wherein the rubber composition further contains a phenolic compound and/or a phenolic resin as a methylene receptor, and hexamethylenetetramine and/or a melamine derivative as a methylene donor,
an amount of the phenolic compound and/or the phenolic resin is 0.5 to 5 parts by mass with respect to the 100 parts by mass of diene rubber, and
an amount of the hexamethylenetetramine and/or the melamine derivative is 0.5 to 2 times the parts by mass of the amount of the phenolic compound and/or the phenolic resin.

10. The pneumatic tire according to claim 2,
wherein the rubber composition further contains a phenolic compound and/or a phenolic resin as a methylene receptor, and hexamethylenetetramine and/or a melamine derivative as a methylene donor,
an amount of the phenolic compound and/or the phenolic resin is 0.5 to 5 parts by mass with respect to the 100 parts by mass of diene rubber, and
an amount of the hexamethylenetetramine and/or the melamine derivative is 0.5 to 2 times the parts by mass of the amount of the phenolic compound and/or the phenolic resin.

11. The pneumatic tire according to claim 1,
wherein the rubber composition further contains 20 to 70 parts by mass of carbon black and 1 to 20 parts by mass of silica, with respect to the 100 parts by mass of diene rubber.

12. The pneumatic tire according to claim 2,
wherein the rubber composition further contains 20 to 70 parts by mass of carbon black and 1 to 20 parts by mass of silica, with respect to the 100 parts by mass of diene rubber.
